(19) United States
(12) Patent Application Publication
(10) Pub. No.: US 2010/0323331 A1
(43) Pub. Date: Dec. 23, 2010

(54) GEAR SHIFTING MECHANISM

(76) Inventors: Kishore Dutt Atluri, Hyderabad (IN); Samson Jayaprakash Anga, Hyderabad (IN)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/812,921

(22) PCT Filed: Jan. 13, 2009
(86) PCT No.: PCT/IN09/00041

§ 371 Date: Jul. 14, 2010

(51) Int. Cl. G09B 9/04

(52) U.S. Cl. 434/71

(57) ABSTRACT

The subject matter described herein is directed to gear shifting and in particular is related to the field of simulation of gear shifting in a vehicle. The present subject matter proposes a strategic solution to eliminate the challenges experienced in the simulation of conventional gear shifting.

### TECHNICAL FIELD

The subject matter described herein in general relates to the field of gear shifting and more particularly relates to the field of simulation of gear shifting in a vehicle.

### BACKGROUND

A conventional vehicle simulator has various control devices such as acceleration pedal, brake pedal, clutch pedal, steering wheel, and gear change lever. Some high end vehicle simulators employ a digital computer to provide a road vehicle driving simulation while other vehicle simulators employ non-digital techniques which emulates actual feel of devices being used while driving a simulator vehicle. Some vehicle simulators also employ actual parts like a gear box assembly to achieve an actual feel of forces felt by the operator while manipulating the gearshift of a vehicle. A compelling reason to use an actual gear box assembly in vehicle simulators is often attributed to the complexity and difficulty involved while designing a gear box simulator which would perfectly emulate actual force felt by operator while manipulating gearshift of a simulator vehicle. However, employing an actual gear box in vehicle simulators brings along inherent disadvantages like a bigger size and hence occupies more space; heavier in weight and hence difficult to mount, dismount and transport. Further, an actual gear box needs to be changed according to the type of vehicle used and hence an actual gear box does not serve optimum purpose for training of all kinds of vehicles. Often mounting of sensors on the actual gear box for the purpose of simulation is also difficult.

### SUMMARY

The subject matter described herein is directed to gear shifting and in particular is related to the field of simulation of gear shifting in a vehicle. The present subject matter proposes a strategic solution to eliminate the challenges experienced in the simulation of conventional gear shifting operation.

In accordance with at least one aspect of the present subject matter, A gear box simulator includes a gear shift lever and a central block having a first end and a second end, wherein the central block is provided with an angular slot that restricts the rotational freedom of the gear shift lever. The gear shift lever is pivotally connected to the central block, wherein the gear shift lever is adapted to move relative to the central block in a first axis. The simulator further comprises a shaft having a first end and a second end, wherein the shaft is provided with a first set and a second set of grooves. The shaft is longitudinally disposed inside the central block wherein the shaft is so connected to the gear shift lever that any forward or backward movement in the first axis of the gear shift lever causes a corresponding movement of the shaft relative to the central block. A first means selectively locks the shaft in any one groove of first set of grooves whereas a second means holds the gear shifting lever, the shaft and the central block at a neutral position. The first means includes a ball, a first spring and a spring backing plate. When the ball gets engaged in any one of the spherically shaped groove of the first set of grooves, the shaft gets locked in a predetermined position. The spring and the spring backing plate does not allow the ball to pop out of the groove, thereby keeps the shaft in a particular position until the gear is changed to the next position. The second means includes a pin, an outer cap and a second spring. The second means holds the gear shifting lever, the shaft, and the central block at a neutral position by virtue of the spring action of the second spring. Further the gear box simulator includes a housing block. Also the central block is adapted to move along with the shaft and the gear shift lever in a second axis.

These and other features, aspects, and advantages of the present subject matter will become better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRAWINGS

The above and other features, aspects and advantages of the subject matter will become better understood with regard to the following description, appended claims, and accompanying drawings where:

FIG. 1 shows the isometric view of the gear shifting mechanism assembly in accordance with an embodiment of the present subject matter.

FIG. 2 shows the isometric exploded view of the gear shifting mechanism assembly in accordance with an embodiment of the present subject matter.

FIG. 3 shows the isometric exploded view rotated about the longitudinal axis in the clockwise direction in accordance with an embodiment of the present subject matter.

### DESCRIPTION

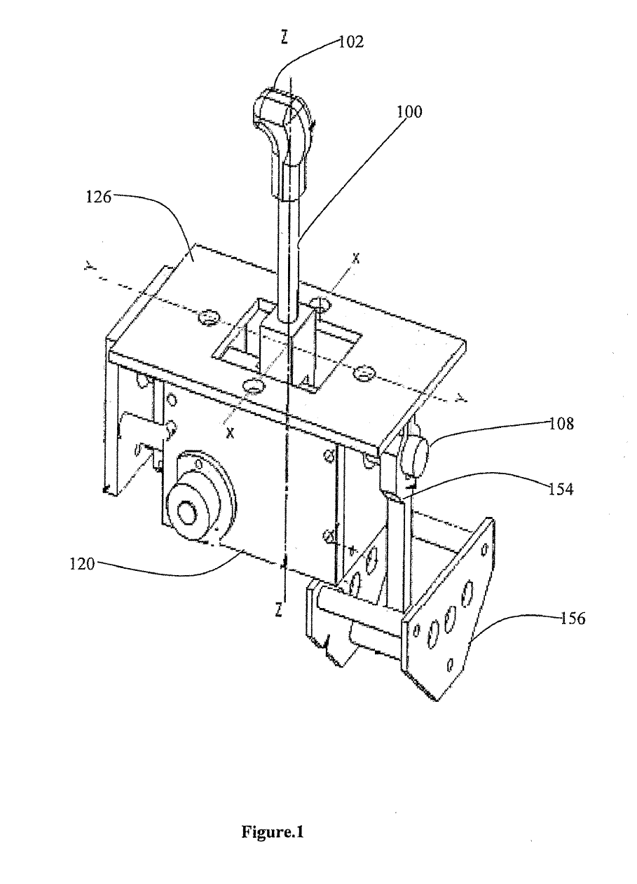

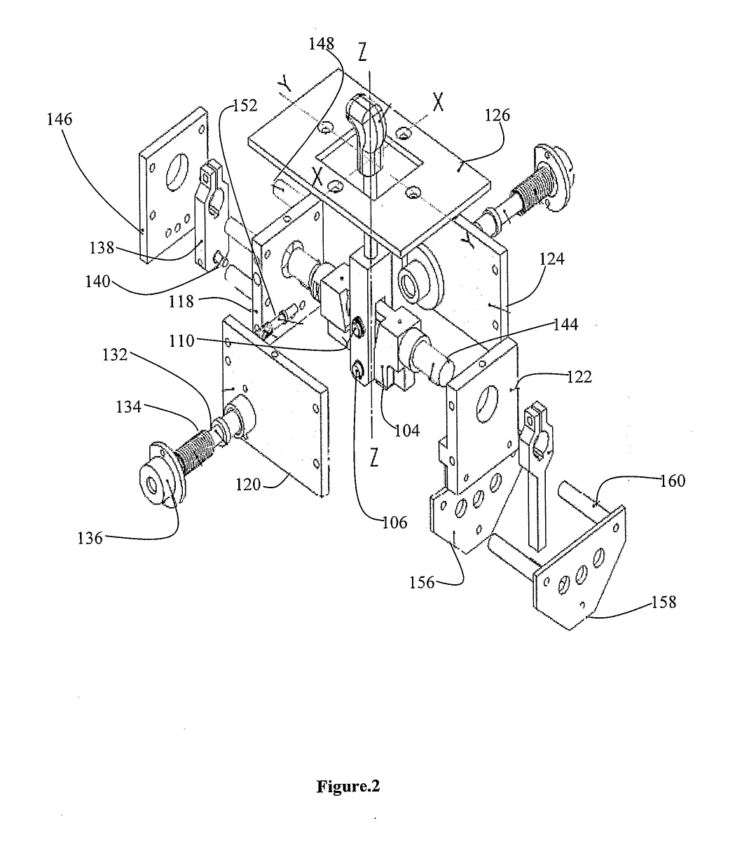

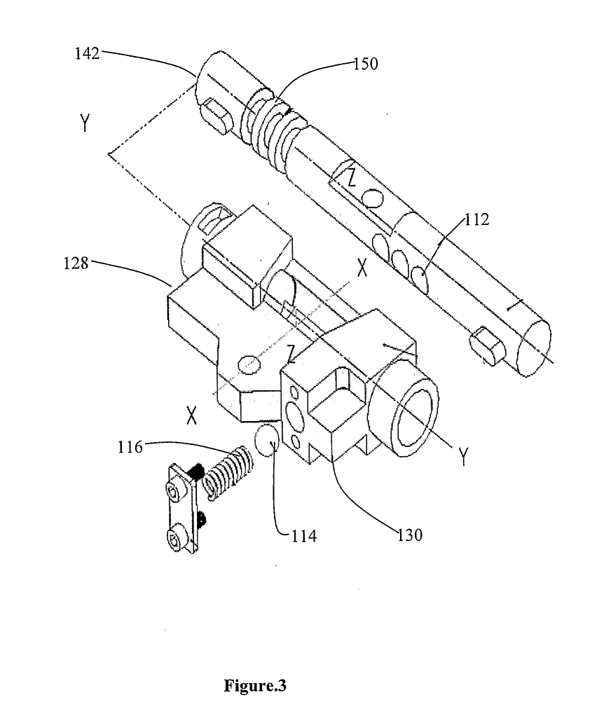

FIG. 1 shows the isometric view of the gear shifting mechanism assembly whereas FIG. 2 shows the isometric exploded view of the gear shifting mechanism assembly in accordance with an embodiment of the present subject matter. FIG. 3 shows the isometric exploded view rotated about the transverse axis in the clockwise direction in accordance with an embodiment of the present subject matter. In the present embodiment, the terms “longitudinal axis” and “first axis” are interchangeably used, while the terms “transverse axis” and “second axis” are interchangeably used.

A gear shifting lever 100 having a gear knob 102 is connected to a central block 104 with a pivot pin 106 and to a shaft 108 through a slot in the gear shifting lever 100 with a push pin 110. The pivot pin 106 facilitates rotational freedom of the gear shifting lever 100 about the transverse axis thereby providing a forward and backward movement to the gear shifting lever 100. When the gear shift lever 100 rotates about the axis of the pivot pin 106, the shaft 108 which is guided inside the central block 104, moves along the longitudinal axis facilitated by the push pin 110.

The shaft 108 has a first set 112 and a second set of grooves 150. A ball 114, loaded with a first spring 116 is placed onto any one groove of the first set of grooves 112 through the central block 104.

The rotational freedom of the gear shift lever 100 is restricted by means of an angular slot provided on the central block 104. The angle in the angular slot can be decided based on the required rotational freedom of the gear shift lever 100. When the shaft 108 is moved along the longitudinal axis by the gear shift lever 100, the ball 114 gets placed in any one groove of the first set of grooves 112. This whole arrangement gives a feel of forward or backward gear engagement.

The assembly of the gear shifting lever 100, the central block 104 and the shaft 108 is housed in an enclosure containing a first housing plate 118, a second housing plate 120, and a third housing plate 122, a fourth housing plate 124 and a fifth housing plate 126. The first housing plate 118 and the third housing plate 122 are located at a first end 128 and a second end 130 respectively of the central block 104. This setup facilitates the rotational freedom of the gear shifting lever 100 about the longitudinal axis of the shaft 108.

A second means comprising of a pin 132, an outer cap 136 and a second spring 134 hold the assembly of gear shifting lever 100, central block 104 and shaft 108 at neutral position, where the neutral position of the assembly is defined as the position of the gear shift lever 100 when it is perpendicular to the transverse and longitudinal axes. The second means are inserted through the housing plate 120 and the housing plate 124.

A locking lever 138 with a locking pin 140 is connected to a first end portion 142 of the shaft 108. A locking plate 146 is fitted to the first housing plate 118 by means of a first pillar set 148, such that the locking plate 146 is substantially parallel to the first housing plate 118. When the gear shifting lever 100 rotates about the axis of the pivot pin 106, then the shaft 108 along with the locking lever 138 moves along the longitudinal axis till the ball 114 sits in any one groove of the first set of grooves 110 provided on the shaft 108. The first housing plate 118 and the locking plate 146 are provided with a set of first and second openings respectively. Based on the forward or backward movement of the gear shifting lever 100, the locking pin 140 selectively gets inserted into any one opening of the first or the second set of openings. The opening on the locking plate 146 or the first housing plate 118 through which the locking pin 140 gets inserted, depends on the orientation of the gear shift lever 100. The shaft 108 has a second set of grooves 150 that are cylindrically shaped. A spring-loaded pin 152 is placed onto the second set of grooves 150 on the shaft 108 through the central block 104. The spring-loaded pin 152 is connected to the clutch pedal of the vehicle. When the clutch pedal is pressed the spring-loaded pin 152 is pulled out of second set of grooves 150. This arrangement does not allow the change of gears unless the clutch pedal is pressed.

A sensing lever 154 is connected to a second end portion 144 of the shaft 108. A first sensing plate 156 is fixed to the gear box housing and the second sensing plate 158 is connected to the first sensing plate 156 by means of a second pillar set 160. The first sensing plate 156 and the second sensing plate 158 are provided with mounting holes, in which sensors or switches are mounted. These sensors detect the gear engaged.

Other advantages of the inventive gear shifting mechanism will become better understood from the description and claims of an exemplary embodiment of such a unit.

The inventive gear shifting mechanism of the present subject matter is not restricted to the embodiments that are mentioned above in the description.

Although the subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter. It is therefore contemplated that such modifications can be made without departing from the spirit or scope of the present subject matter as defined.

I/We claim:

1. A gear box simulator for a vehicle, said gear box simulator comprising:
a gear shift lever (100);
a central block (104) having a first end (128) and a second end (130), wherein said central block (104) is provided with an angular slot that restricts the rotational freedom of said gear shift lever (100),
said gear shift lever (100) is pivotally connected to said central block (104), wherein said gear shift lever (100) is adapted to move relative to said central block (104) in a first axis;
a shaft (108) having a first end (142) and a second end (144), wherein said shaft (108) is provided with a first set (112) and a second set of grooves (150),
said shaft (108) is longitudinally disposed inside said central block (104) wherein said shaft (108) is so connected to said gear shift lever (100) that any forward or backward movement in said first axis of said gear shift lever (100) causes a corresponding movement of said shaft (108) relative to said central block (104);
a first means (114, 116), wherein said first means (114, 116) selectively locks said shaft (108) in any one groove of said first set of grooves (112);
a second means (132, 134, 136); and
a housing block;
wherein said central block (104) is adapted to move along with said shaft (108) and said gear shift lever (100) in a second axis, and wherein said second means (132, 134, 136) holds said gear shifting lever (100), said shaft (108) and said central block (104) at a neutral position.

2. The gear box simulator as claimed in claim 1, wherein a locking means is operably connected to a clutch pedal of said vehicle, said locking means restricts changing of gear by engaging in any one groove of said second set of grooves (150), said locking means gets disengaged on pressing said clutch pedal.

3. The gear box simulator as claimed in claim 1, wherein said first means (114, 116) provides variable resistance when shifting said gear shift lever (100) out of and between said first set of grooves (112).

4. The gear box simulator as claimed in claim 1, wherein said housing block retains said second means (132, 134, 136), thereby resiliently holding said central block (104) at the neutral position.

5. The gear box simulator as claimed in claim 1, wherein said first means comprises a ball (114), a first spring (116) and a spring backing plate.

6. The gear box simulator as claimed in claim 1, wherein said second means comprises a pin (132), an outer cap (136) and a second spring (134).

7. The gear box simulator as claimed in claim 1, wherein a first housing plate (118) is disposed at said first end (128) of said central block (104), and a locking plate (146) is fitted to said first housing plate (118) by means of a first pillar set (148) such that said housing plate (118) and said locking plate (146) are substantially parallel to each other, and wherein said first housing plate (118) and said locking plate (146) are provided with a set of first and second openings respectively.

8. The gear box simulator as claimed in claim 7, wherein a locking lever (138) with a locking pin (140), is mounted on said first end portion (142) of said shaft (108) such that any forward or backward movement of said gear shift lever (100) in the first axis, selectively engages said locking pin (140) onto any one opening of said first or second set of openings.

9. The gear box simulator as claimed in claim 1, wherein a sensing lever (154) is operably connected to said second end portion (144) of said shaft (108).
